(19) United States
(12) Patent Application Publication
(10) Pub. No.: US 2020/0318304 A1
(43) Pub. Date: Oct. 8, 2020

(54) EXTENDABLE AND FLEXIBLE SNOW THROWING DEVICE

(71) Applicant: Lisa Pietracatella, Staten Island, NY (US)

(72) Inventor: Lisa Pietracatella, Staten Island, NY (US)

(21) Appl. No.: 16/822,979

(22) Filed: Mar. 18, 2020

Related U.S. Application Data
(60) Provisional application No. 62/819,910, filed on Mar. 18, 2019.

(51) Int. Cl. E01H 5/09; B60S 3/04; E01H 5/10

(52) U.S. Cl. CPC E01H 5/092; E01H 5/10; E01H 5/098; B60S 3/048

(57) ABSTRACT

An extendable and flexible snow thrower includes a handle, an extendable section, and an end section. A power unit is also integrated into one of the components of the snow thrower. The power unit includes a rechargeable battery. The snow thrower also includes the handle which is composed of an ergonomic shape and material that aids in comfortable use. In addition, the expendable section is flexible for directional disposal of snow or ice. Furthermore, the end section includes a rotary brush with a heating element. Heat from the heating element is radiated through metallic protrusion(s) situated in between bristle(s). The radiated heat may aid in loosening the snow or ice from an operational surface. The loosened snow or ice is routed through the end section for disposal.

### CLAIM OF PRIORITY

This application claims priority under 35 U.S.C. § 119 to U.S. provisional application No. 62/819,910 filed on Mar. 18, 2019 in the United States Patent and Trademark Office, the entire disclosure of which is incorporated herein by reference.

### FIELD OF THE EMBODIMENTS

The field of the present invention and its embodiments relate to an extendable and flexible snow throwing device with an extendable and/or flexible section to accommodate a diversity of use case scenarios involving demanding and difficult to reach locations.

### BACKGROUND OF THE EMBODIMENTS

Significant proportion of population centers are affected by snow fall. Snow fall in large quantities accumulate and hinder activities in daily life. For example, people are forced to clean up accumulated snow from cars, driveways, and other structures that impact their daily routines. Snow may melt and refreeze as ice which may further complicate and burden cleanup efforts. Additionally, unchecked, accumulated snow may compact and damage weight sensitive structures.

Snow or ice removal is a cumbersome process that requires significant effort and time. Variety of devices exist to aid in snow removal. However, most devices help with removal from expansive surfaces such as driveways. Such devices fail or manage poorly removal scenarios that include small or difficult to reach surfaces.

For instance, U.S. Pat. No. 4,255,880 pertains to a portable rotary snow thrower with a housing that is configured to throw the snow in a direction associated with a rotation of the rotor or the opposite direction. The snow thrower disposes of snow through a same opening without repositioning of baffles.

U.S. Pat. No. 4,329,792 pertains to a snow remover with blades throwing the snow rearward and upward. The snow remover has direct drive relationship between a rotor and a motor and an entire motor-rotor housing is connected with a handle which is selectively adjustable relative to the direction of throw of the rotor.

U.S. Pat. No. 4,377,044 pertains to a snow thrower that is configured for use in a shoveling motion or in a push or pull motion. The snow thrower includes a forward handgrip portion that is located on the same axis as that of the handle.

U.S. Pat. No. 5,161,318 pertains to a power sweeping tool with a sweeper made of a pair of drums mounted for rotation with fins extending outward.

U.S. Pat. No. 5,603,173 pertains to a snow thrower with an impeller that is configurable with an adjustable rotational speed. A lower portion of the drive shaft (of the snow thrower) is curved and extends through an impeller housing.

U.S. Pat. No. 6,643,958 pertains to snow throwing shovel device with a scoop assembly and chute for disposal. The snow is picked up and moved through the elongated chute.

Various systems and methodologies are known in the art. However, their structure and means of operation are substantially different from the present disclosure. The other inventions fail to solve all the problems taught by the present disclosure. At least one embodiment of this invention is presented in the drawings below and will be described in more detail herein.

### SUMMARY OF THE EMBODIMENTS

The present invention and its embodiments relate to an extendable and flexible snow throwing device that is configured to remove snow or ice from a surface. The extendable and flexible snow throwing device may include a handle, a power unit, an extendible section that is connected to the handle and the power unit. the extendable section may be flexible. The extendable and flexible snow throwing device may also include an end section that is connected to the extendable section. The end section may include a rotary brush with a bristle and a metallic protrusion connected to a heating element.

In another embodiment of the present invention, an extendable and flexible snow throwing device may be described. The extendable and flexible snow throwing device may include a handle. The handle may be shaped to accommodate a right or left handed grip. An extendable section may be connected to the handle. The extendable section may include a rechargeable battery. The extendable section may be connected to an end section. The end section may include a rotary brush with a heating element, a bristle, and a metallic protrusion. The metallic protrusion may be positioned adjacent to the bristle and may be configured to radiate heat form the heating element.

In yet another embodiment of the present invention, a method of cleaning snow from a surface with the extendable and flexible thrower is described. A user may initiate a trigger event to activate the extendable and flexible thrower. The trigger event may be an activation of an operational control (by a user) or a response to external stimuli such as input from an external sensor (such a contact sensor). In response to the trigger event, the extendable and flexible thrower may activate a heating element enclosed by a rotary brush in an end section of the snow thrower. Heat may be generated by the heating element and radiated through metallic protrusions placed in between bristles of the rotary brush. The heat may be used to melt or loosen snow or ice on a surface. Next, upon detecting contact with the snow or ice on the surface, the rotary brush may be rotated. The rotation speed of the rotary brush may be adjustable to control flow of snow removal. The rotary brush may next loosen the snow or ice from the surface. In addition, the loosened snow or ice may be channeled through the end section for disposal.

It is an object of the present invention to provide an extendable and flexible snow throwing device that is expandable and collapsible to accommodate a variety of snow removal scenarios including difficult to reach areas.

It is an object of the present invention to provide an extendable and flexible snow throwing device that is collapsible for storage and ease of transportation.

It is an object of the present invention to provide an extendable and flexible snow throwing device that curves and/or bends to adjust a direction of snow disposal.

It is an object of the present invention to provide an extendable and flexible snow throwing device that heats and melts the snow to aid in removal and disposal.

### BRIEF DESCRIPTION OF THE DRAWINGS

FIG. 1 shows an exploded view of an embodiment of the present invention.

FIGS. 2A-2C show side views of embodiments of the present invention.

FIG. 3A shows an exploded view of an end section of an embodiment of the present invention.

FIG. 3B shows another exploded view of an end of section of an embodiment of the present invention.

FIGS. 4A-4B show side views of embodiments of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

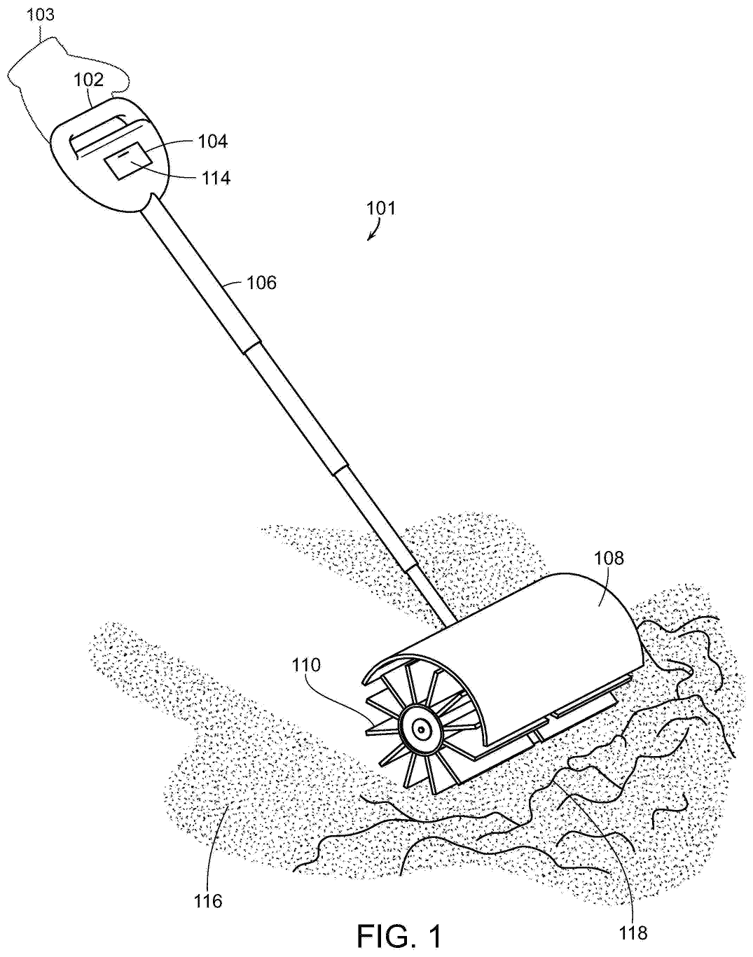

FIG. 1 shows an extendable and flexible snow throwing device 101 with three primary sections. The extendable and flexible snow throwing device 101 includes a handle 102, an extendable section 106, and an end section 108. The extendable and flexible snow throwing device 101 may be made of lightweight, sturdy, and durable materials such as plastic, aluminum, and/or composite materials, among others. Furthermore, the extendable and flexible snow throwing device 101 may incorporate cost saving materials and structures to manufacture an inexpensive product.

The handle 102 may include an ergonomic shape that may aid comfort during use. The ergonomic shape may include a grip shaped to accommodate a natural curvature of a hand. The handle 102 may be made with soft material(s) such as organic material(s), leather, or plastic polymer(s) that mimic organic material(s), among others. The handle 102 may also include a glove or mitten 103 to protect a user's hand during operation of the extendable and flexible snow throwing device 101. The glove or mitten 103 may be integrated to the handle 102. Alternatively, the glove or mitten 103 may be attachable to the handle 102.

The handle 102 may enclose a power unit 104. The power unit 104 may include a rechargeable battery 114. A size of the power unit 104 and a number of the rechargeable battery 114 may scale up and down based on power requirements of the extendable and flexible snow throwing device 101. In addition, the power unit 104 may include other forms of power generation such as an engine that consumes petroleum chemicals, and/or alcohol, among other fuel sources. Furthermore, the power unit 104 may be placed in other sections of the extendable and flexible snow throwing device 101.

The extendable section 106 may extend and collapse based on user configuration of the extendable and flexible snow throwing device 101. A user may manually (or automatically) pull on the handle 102, the extendable section 106, or the end section 108 to extend the extendable section 106 up to a maximum length. Alternatively, the user may manually (or automatically) push on the handle 102, the extendable section 106 or the end section 108 to collapse the extendable section 106 down to a minimum length. The length of the extendable section 106 may be user configurable to suit a use case scenario that may demand a preconfigured length.

The extendable section 106 may also be bent to point the end section 108 in a different direction than the handle 102. The user may bend the extendable section 106 to point the end section 108 to a desired configuration for utilizing the extendable and flexible snow throwing device 101 in a curved or bent manner. Furthermore, an angle between the handle 102 and the extendable section 106 may be user adjustable to accommodate directional use case scenarios. Similarly, an angle between the extendable section 106 and the end section 108 may be user adjustable to accommodate directional use case scenarios. The end section 108 may also include a chute to route snow or ice 118 removed from a surface 116. The chute may be rotatable to allow for directional disposition of the snow or ice 118.

Examples of the surface 116 may include various exterior surfaces of a vehicle such as a hood, a roof, or a trunk, among others. Examples of the surface 116 may also include an exterior step, a wall, or a driveway, among others. In an example embodiment, the end section 108 may be placed on the surface 116 to initiate removal of snow or ice 118. The extendable and flexible snow throwing device 101 may rotate a rotary brush 110 (attached to the end section 108) through a motor or other mechanism powered by the power unit 104. The extendable and flexible snow throwing device 101 may have contact sensors that automatically turn on the rotary brush 110 when on the snow or ice 118. When in operation, the rotary brush 110 may rotate and loosen the snow or ice 118. The loosened snow and/or ice may be routed through the end section 108 for disposal of the snow or ice 118.

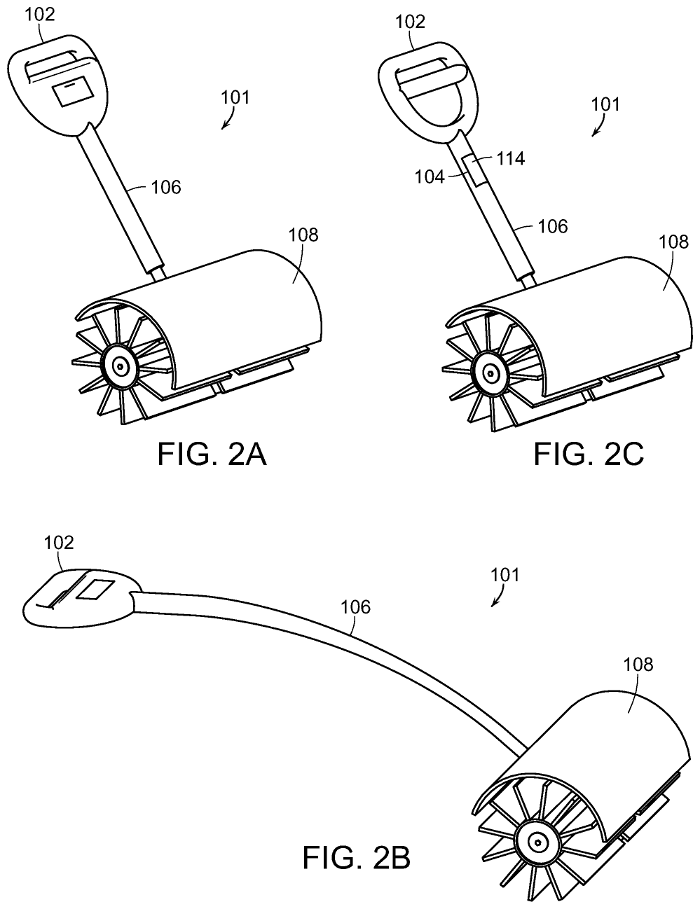

FIGS. 2A-2C show embodiments of the extendable and flexible snow throwing device 101 in various configurations. For example, FIG. 2A shows the extendable and flexible snow throwing device 101 in a collapsed state. To collapse an extendable section 106, a user may choose to push on the handle 102 while the end section 108 is secured on a surface. The extendable and flexible snow throwing device 101 in a collapsed state may optimally operate in tight spaces by providing the user with a compact form factor. Furthermore, the extendable and flexible snow throwing device 101 in a collapsed state may be easier to transport and may easily fit into a small carrying bag or container for transportation. In the collapsed state, the extendable and flexible snow throwing device 101 may easily be transportable in a smaller container such as a transportation bag.

FIG. 2B shows the extendable and flexible snow throwing device 101 in a bent form factor. The expendable section 206 is flexible. The expendable section 106 may be configured in a curved or bent configuration by a user for directional use of the extendable and flexible snow throwing device. Sufficient force applied by the user to any one of the handle 102, the expendable section 106, or the end section 108 (while securing another section) may configure the expendable section 106 in a bent or curved form. The bent or curved form of the extendable and flexible snow throwing device 101 may aid in snow or ice removal around obstacles. The bent or curved form may also provide directional disposal of snow or ice.

FIG. 2C shows the extendable and flexible snow throwing device 101 with the power unit 104 enclosed in the extendable section 106. The power unit 104 may include the rechargeable battery 114. It may be advantageous to store the power unit 104 within the extendable section 106 for power considerations. For example, proximate placement of the power unit 104 in relation to a motor (spinning a rotary brush) may aid in efficient delivery of available power for extended consumption. Proximate placement may be advantageous compared to scenarios involving inefficient placement of the power unit 104 in relation to the motor. Alternatively, shape considerations associated with components of the extendable and flexible snow throwing device 101 may make it preferable to enclose the power unit in the extendable section 106 or another section (such as the end section 108).

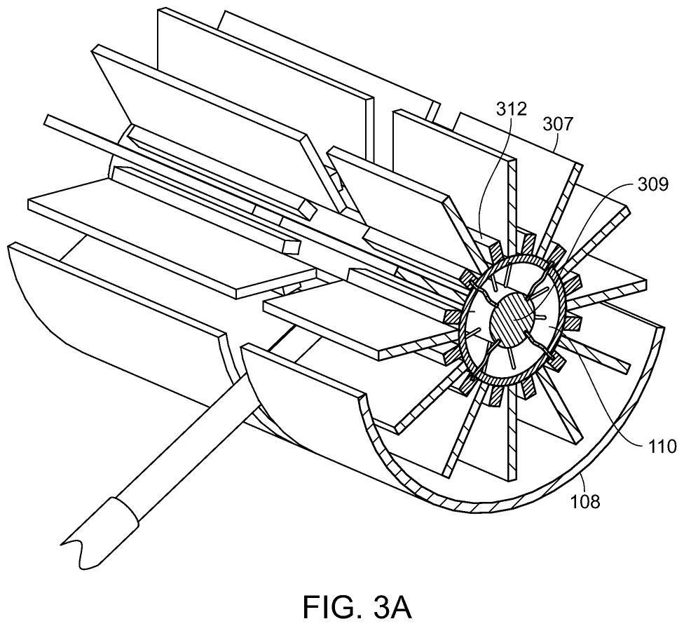

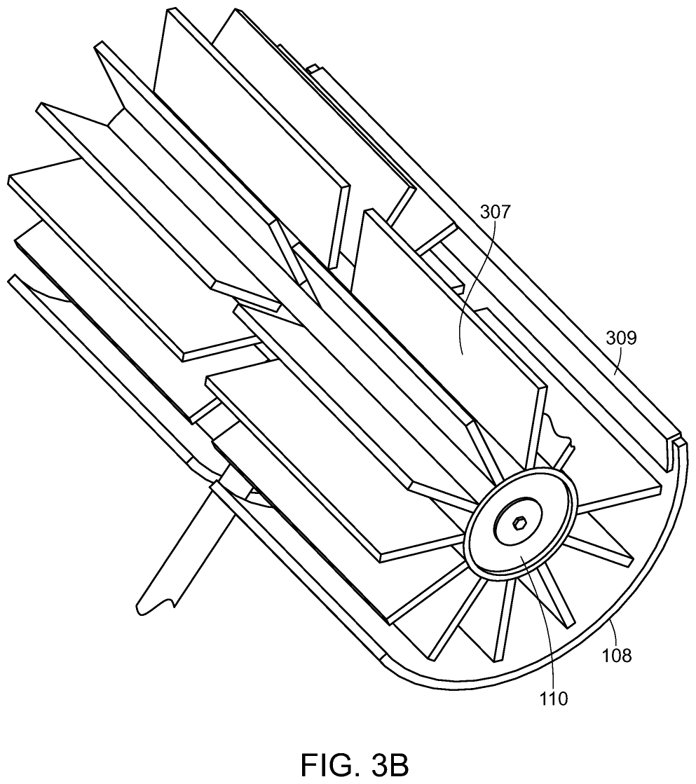

FIG. 3A shows an exploded view of the end section 108 of a snow throwing device. The end section 108 encloses multiple components that scrape, move, and dispose snow or ice from a surface of operation. The end section 308 includes the rotary brush 110 with a bristle 307 and a metal protrusion 312. The metal protrusion 312 may be attached to a heating element 309. The metal protrusion 312 may radiate heat generated by the heating element 309 to melt snow or ice. Melting the snow or ice may aid in loosening the snow or ice from the surface.

The rotary brush 110 may enclose the heating element 309 in a core section. The metal protrusion 312 may be placed adjacent to the bristle 307. As such, the rotary brush 110 may be surrounded by a number of bristles 307 and metal protrusions 312. The metal protrusions 312 would continuously radiate heat from the heating element 309 during the operation of the rotary brush 110. The rotary brush 110 may also be removable to allow for cleaning of the rotary brush 110.

Furthermore, a length of the metal protrusion 312 may be shorter than a length of the bristle 307 to prevent scratching of the surface during the operation of the rotary brush 110. Additionally, a tip of the metal protrusion 312 (away from the rotary brush 110) may be coated with non-scratching material to prevent scratching of the surface during the operation of the rotary brush 110. Furthermore, the metal protrusion 312 may be made of bendable composite to prevent scratching of the surface during the operation of the rotary brush 110.

The amount of heat (generated by the heating element 309 and dispersed by the metal protrusion 312) may be user adjustable. For example, a user may configure a temperature setting on a control associated with the operation of the heating element 309. Alternatively, the temperature of the heating element 309 may be configured automatically based on a heat sensor associated with the extendable and flexible snow throwing device. The heat sensor may detect a temperature of the snow or ice and automatically adjust the temperature of the heating element 309 based on an optimal configuration to melt the snow or ice. In an example scenario, the heat sensor may be placed below the end section 108 and may be oriented toward the snow or ice on the surface.

A rotational speed of the rotary brush 110 may also be user adjustable. The user may configure the rotational speed on a control associated with the operation of the rotary brush 110. The rotational speed of the rotary brush 110 may be increased to route a higher volume of snow or ice through the end section 108 for disposal. Alternatively, the rotational speed of the rotary brush 110 may be decreased to route a lower volume of snow or ice through the end section 108 for disposal. The rotational speed of the rotary brush 110 may also be variable and adjustable based on a manual input by the user or automatically based on input from sensory components such as snow and/or ice temperature detector, among others.

FIG. 3B shows another exploded view of the end section 108 of a snow throwing device. The end section 108 includes the rotary brush 110 that may loosen and propel snow or ice through the end section 108 for disposal. The rotary brush 110 may include the bristle 307 that scrapes the snow or ice when the rotary brush 110 is in operation. In an example scenario, a sensor on the extendable and flexible snow throwing device 101 (such as a contact sensor) may detect placement of the end section 108 on a surface. Such an event may trigger activation of the rotary brush 110 that may scrape and remove the snow or ice from the surface. The contact sensor may be placed below the end section 108 and may be oriented toward the snow or ice on the surface.

In another example scenario, the end section 108 may include the heating element 309. The heating element 309 may be activated synchronously with the rotary brush 110 to loosen the snow or ice from the surface. Radiating heat from the heating element 309 may aid in loosening the snow or ice from the surface and help with removal. The heating element 309 may also be manually activated or deactivated by the user in scenarios where the user may wish to loosen the snow or ice with heat prior to disposal using the rotary brush 110.

The heating element 309 may be placed before the rotary brush 110 or after the rotary brush 110. An amount of heat radiating from the heating element 309 may be adjusted manually. Alternatively, the amount of heat may be adjusted automatically based on external factors such as the temperature of the snow or ice or other external factors (such as ambient temperature or the temperature of the surface) detected through sensor(s) or external input.

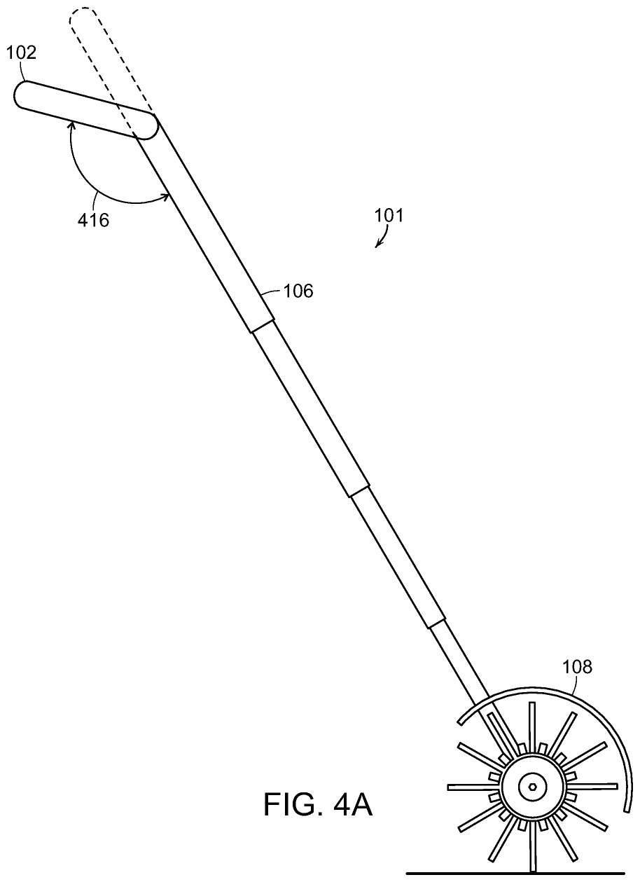

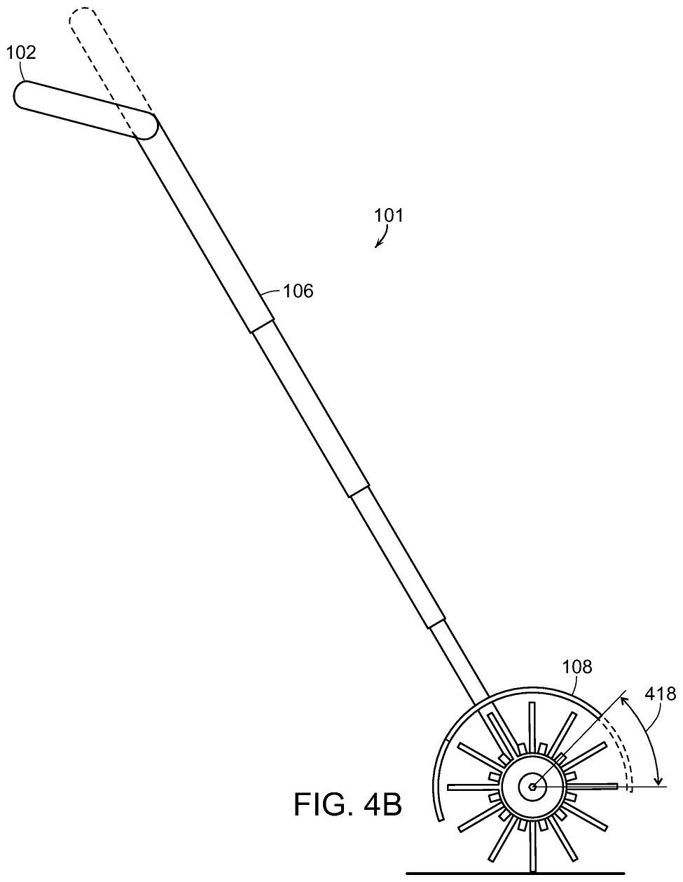

FIGS. 4A-4B show side views of the extendable and flexible snow throwing device 101. FIG. 4A illustrates a directional usage scenario for snow or ice removal. A user may adjust an angle 416 between the handle 102 and the extendable section 106. As a result, the snow or ice (that is removed from a surface) may be disposed from the end section 108 at a direction determined by the angle 416.

FIG. 4B shows an alternative directional usage scenario in which a user may adjust an angle 418 and length between the end section 108 and the extendable section 106. The angle 418 may determine the disposal direction for the snow or ice removed from the surface by the end section 108.

The user may adjust the angles (416 and/or 418) manually. Alternatively, the user may be provided with controls and functionality to automatically adjust the angles (416 and/or 418). For example, an actuator may be used between the handle 102, the extendable section 106, or the end section 108 to adjust the angles (416 and/or 418) associated with the components.

A method of cleaning snow from a surface with the extendable and flexible snow thrower is also described. A user may initiate a trigger event to activate the extendable and flexible snow thrower. The trigger event may be an activation of an operational control (by a user) or a response to external stimuli such as input from an external sensor (such a contact sensor). In response to the trigger event, the extendable and flexible snow thrower may activate a heating element enclosed by a rotary brush in an end section of the snow thrower. Heat may be generated by the heating element and radiated through metallic protrusions placed in between bristles of the rotary brush. The heat may be used to melt or loosen snow or ice on a surface. Next, upon detecting contact with the snow or ice on the surface, the rotary brush may be rotated. The rotation speed of the rotary brush may be adjustable to control flow of snow removal. The rotary brush may next loosen the snow or ice from the surface. In addition, the loosened snow or ice may be sent through the end section for disposal.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. An extendable and flexible snow throwing device comprising:
a handle;
a power unit;
an extendable section coupled to the handle and the power unit, wherein the extendable section is flexible; and
an end section coupled to the extendable section,
wherein the end section includes a rotary brush with a bristle and a metallic protrusion coupled to a heating element.

2. The device of claim 1, wherein the power unit includes a rechargeable battery.

3. The device of claim 1, wherein an angle of the end section in relation to the extendable section is adjustable.

4. The device of claim 1, wherein the rotary brush includes the heating element.

5. The device of claim 1, wherein the metallic protrusion is positioned adjacent to the bristle.

6. The device of claim 1, wherein a length of the metallic protrusion is shorter than a length of the bristle.

7. The device of claim 1, wherein the metallic protrusion is configured to radiate heat generated by the heating element.

8. The device of claim 1, wherein a temperature of the metallic protrusion is configurable based on an adjustable operation of the heating element.

9. The device of claim 1, wherein the extendable section is configured to extend or collapse manually.

10. The device of claim 1, wherein the extendable section is configured to extend or collapse automatically based on an operation of an actuator.

11. The device of claim 1, wherein a rotation speed of the rotary brush is configurable based on an adjustable operation of the rotary brush.

12. An extendable and flexible snow throwing device comprising:
a handle, wherein the handle is shaped to accommodate a right or left handed grip;
an extendable section coupled to the handle, wherein the extendable section includes a rechargeable battery; and
an end section coupled to the extendable section,
wherein the end section includes a rotary brush with a heating element, a bristle, and a metallic protrusion, the metallic protrusion being positioned adjacent to the bristle and is configured to radiate heat from the heating element.

13. A method of cleaning snow from a surface with an extendable and flexible snow thrower, the method comprising:
detecting a trigger event to activate the extendable and flexible snow thrower, wherein the snow thrower includes an ergonomic handle, an extendable section coupled to the ergonomic handle, and an end section coupled to the extendable section;
activating a heating element within a rotary brush of the end section;
radiating heat through a metallic protrusion coupled to the heating element, wherein the metallic protrusion is positioned adjacent to a bristle of the rotary brush;
detecting the end section contact snow or ice on the surface;
rotating the rotary brush at an adjustable rotation speed;
loosening the snow or ice from the surface; and
sending the loosened snow or ice through the end section.
